(19) United States
(12) Patent Application Publication
(10) Pub. No.: US 2026/0344655 A1
(43) Pub. Date: Nov. 5, 2026

(54) METHOD FOR PREPARING MITOCHONDRIA FOR CARDIAC TRANSPLANTATION, KIT THEREFOR, AND COMPOSITION FOR TREATING ISCHEMIC HEART DISEASE COMPRISING THE SAME AS AN ACTIVE INGREDIENT

(71) Applicant: CHUNG ANG University Industry Academic Cooperation Foundation, Seoul (KR)

(72) Inventors: JAE HONG KO, Seoul (KR); KI WOON KANG, Seoul (KR)

(21) Appl. No.: 19/657,766

(22) Filed: Apr. 24, 2026

(30) Foreign Application Priority Data
Apr. 25, 2025 (KR) 10-2025-0054816
Jul. 11, 2025 (KR) 10-2025-0093680

(51) Int. Cl. A01N 1/14; A01N 1/126

(52) U.S. Cl. CPC A01N 1/14; A01N 1/126

(57) ABSTRACT

Disclosed are a method of preparing mitochondria for transplantation into the heart, exhibiting excellent protective effects against ischemia-reperfusion injury, and use of such mitochondria, and more particularly, a method and kit for preparing such mitochondria for transplantation into the heart, the mitochondria prepared by the method, and a method of preventing or treating ischemic heart disease including administering such mitochondria for transplantation into the heart of a subject with ischemic heart disease. The method of preparing mitochondria for transplantation enables efficient production of mitochondria having high functional integrity. The mitochondria prepared by the method have an effect of regulating expression of fatty acid metabolism-related genes, Cpt1b and Fads1, to normal levels upon transplantation of mitochondria into the heart, and restore myocardial energy metabolism disrupted by ischemia-reperfusion injury, thus enhancing cardioprotective effects upon ischemia-reperfusion injury and being useful for prevention or treatment of ischemic heart disease.

### TECHNICAL FIELD

The present invention relates to a method of preparing mitochondria for transplantation into the heart, which exhibits excellent protective effects against ischemia-reperfusion injury, and use of the mitochondria, and more particularly, to a method and a kit for preparing the mitochondria for transplantation into the heart, the mitochondria for transplantation into the heart, prepared by the method, and a method of preventing or treating ischemic heart disease including administering the mitochondria for transplantation into the heart to a subject with ischemic heart disease.

### TECHNICAL BACKGROUND OF THE INVENTION

Ischemic heart disease (IHD) is a disease that is caused by a reduction in the supply of blood and oxygen to the myocardium caused by stenosis or occlusion of the coronary arteries, and is one of the major causes of death among patients with cardiovascular diseases. According to the Health Insurance Review and Assessment Service, the number of patients with ischemic heart disease in Korea increased from 910,122 in 2018 to 1,027,842 in 2022 at an average annual rate of 3.1%, and medical expenses have also increased at an average annual rate of 5.9%. In particular, the number of patients with angina and myocardial infarction increased at average annual rates of 1.5% and 4.6%, respectively. Therefore, there is an urgent need for the development of effective therapeutic methods.

The pathophysiological mechanism of ischemic heart disease is as follows. When the left ventricular myocardium does not receive sufficient blood flow to meet metabolic demand, ischemic injury occurs in myocardial tissue. Thereafter, when reperfusion occurs, innate and adaptive immune responses and cell death programs are activated, thus further aggravating myocardial injury, which is referred to as “ischemia-reperfusion (IR) injury”. When oxygen and respiratory substrates are deficient due to ischemia, the TCA cycle and oxidative phosphorylation of mitochondria are interrupted and the mitochondrial membrane potential collapses, thus inducing oxidative damage and cell death (Fuhrmann & Brüne, 2017; Leist et al., 1997; Lesnefsky et al., 2004). In addition, IR facilitates Ca²⁺ overload and the generation of reactive oxygen species (ROS), thus opening the mitochondrial permeability transition pore (mPTP), releasing cytochrome C into the cytoplasm to activate caspase-3, and leading to cell death (Trankle et al., 2016).

Mitochondria are essential organelles that supply energy required for cell survival through ATP synthesis, and are involved in cell signaling, cell differentiation, apoptosis, the cell cycle, and regulation of cell growth. In particular, in cardiomyocytes, mitochondria account for 30% or more of the cell volume, supply 95% of ATP required for cardiac contraction, and act as a metabolic hub for oxidative phosphorylation, the citric acid cycle, and fatty acid β-oxidation.

As a pharmacological approach for treating ischemia-reperfusion injury, cyclosporine, MTP-131, TRO4030 and the like have been used to inhibit mitochondrial membrane permeability and prevent cell death. However, the exact mechanisms of action have not yet been elucidated and thus there are clinical limitations. As an alternative thereto, mitochondrial transplantation has been attracting attention.

Meanwhile, it has been reported that, although functions of transplanted mitochondria have rapidly decreased within 1 hour under ex vivo culture conditions, the mitochondria remain viable for 28 days within the myocardium, and most thereof fuse with conventional mitochondria to form a network. As a mechanism for intracellular uptake of mitochondria, actin-dependent endocytosis is the most well-known.

However, the functional integrity of isolated mitochondria may vary significantly depending on the composition of the buffer used in the isolation process, and it is difficult to achieve sufficient therapeutic effects from transplantation of mitochondria with reduced function. Conventional methods for isolating mitochondria generally use a sucrose-based buffer or a buffer containing an ingredient such as EGTA, but have a limitation of insufficient functional integrity for use in transplantation into the heart.

Under such background, the present inventors developed a method of isolating mitochondria having functional integrity suitable for transplantation into the heart, and found that, when mitochondria isolated by the method were transplanted into a heart after reproducing an IR injury environment ex vivo using a Langendorff system, excellent therapeutic effects on ischemic heart disease were achieved. Based on this finding, the present invention has been completed.

The information disclosed in this Background section is provided only for better understanding of the background of the present invention, and therefore it may not include information that forms the prior art that is already obvious to those skilled in the art.

### DESCRIPTION OF THE INVENTION

### Problem to be Solved

Therefore, the present invention has been made in view of the above problems, and it is one object of the present invention to provide a method of preparing mitochondria for transplantation into the heart that has a cardioprotective effect against ischemia-reperfusion injury when transplanted into a heart.

It is another object of the present invention to provide a kit for preparing the mitochondria for transplantation into the heart.

It is another object of the present invention to provide mitochondria for transplantation into the heart prepared by the method.

It is another object of the present invention to provide a medical composition for preventing or treating ischemic heart disease containing the mitochondria for transplantation into the heart as an active ingredient.

It is another object of the present invention to provide a method of preventing or treating ischemic heart disease including administering the mitochondria for transplantation into the heart to a subject with ischemic heart disease.

It is another object of the present invention to provide use of the mitochondria for transplantation into the heart for the prevention or treatment of ischemic heart disease.

It is another object of the present invention to provide use of the mitochondria for transplantation into the heart for the preparation of a drug for preventing or treating ischemic heart disease.

### Means of Solving the Problem

In accordance with one aspect of the present invention, the above and other objects can be accomplished by the provision of a method of preparing mitochondria for transplantation into the heart including (a) mixing and homogenizing an isolated tissue with a first buffer containing 150 mM to 280 mM sucrose, 0.1 mM to 5 mM ethylene diamine tetraacetic acid (EDTA), and 5 mM to 40 mM Tris-base, followed by centrifugation to obtain a pellet containing mitochondria, and (b) resuspending the pellet containing mitochondria in a second buffer containing 0.1 mM to 5 mM EDTA, 5 mM to 40 mM Tris-base, 100 mM to 300 mM KCl, and 0.5 to 1.5 g/L of bovine serum albumin (BSA), followed by centrifugation to obtain mitochondria for transplantation into the heart.

In accordance with another aspect of the present invention, provided is a kit for preparing mitochondria for transplantation into the heart including a first buffer containing 150 mM to 280 mM sucrose, 0.1 mM to 5 mM EDTA, and 5 mM to 40 mM Tris-base, and a second buffer containing 0.1 mM to 5 mM EDTA, 5 mM to 40 mM Tris-base, 100 mM to 300 mM KCl, and 0.5 g/L to 1.5 g/L of BSA.

In accordance with another aspect of the present invention, provided are mitochondria for transplantation into the heart prepared by the method.

In accordance with another aspect of the present invention, provided is a medical composition for preventing or treating ischemic heart disease containing the mitochondria for transplantation into the heart as an active ingredient.

In accordance with another aspect of the present invention, provided is a method of preventing or treating ischemic heart disease including administering the mitochondria for transplantation into the heart to a subject with ischemic heart disease.

In accordance with another aspect of the present invention, provided is use of the mitochondria for transplantation into the heart for the prevention or treatment of ischemic heart disease.

In accordance with another aspect of the present invention, provided is use of the mitochondria for transplantation into the heart for the preparation of a drug for preventing or treating ischemic heart disease.

### Effect of the Invention

The method of preparing mitochondria for transplantation into the heart according to the present invention enables efficient production of mitochondria for transplantation into the heart having high functional integrity. The mitochondria prepared by the method of the present invention have an effect of regulating expression of fatty acid metabolism-related genes, Cpt1b and Fads1, to normal levels upon transplantation of mitochondria into the heart, and restore myocardial energy metabolism disrupted by ischemia-reperfusion injury, thereby enhancing cardioprotective effects upon ischemia-reperfusion injury. Accordingly, the present invention may be utilized for prevention or treatment of ischemic heart disease.

### BRIEF DESCRIPTION OF THE DRAWINGS

The above and other objects, features and other advantages of the present invention will be more clearly understood from the following detailed description taken in conjunction with the accompanying drawings, in which:

FIG. 1A schematically illustrates process of establishing a cardiac ischemia model according to the present invention;

FIG. 1B is an image showing an example of an experimental configuration of a Langendorff system used for cardiac perfusion and mitochondrial transplantation in the present invention;

FIG. 1C shows a non-ischemic region at an end point of an animal experiment according to the present invention;

FIG. 2 shows a mitochondrial respiratory control ratio (RCR) after mitochondrial transplantation of the present invention;

FIG. 3 shows a mitochondrial copy number after mitochondrial transplantation of the present invention;

FIG. 4 shows a ratio of the respiratory control ratio (RCR) to the mitochondrial copy number after mitochondrial transplantation of the present invention; and

FIG. 5 shows relative expression levels of cardiac genes (Cpt1b, Elov15, Fads1, Gja1) associated with fatty acid energy metabolism after mitochondrial transplantation of the present invention.

### SPECIFIC DETAILS FOR IMPLEMENTING THE INVENTION

Unless defined otherwise, all technical and scientific terms used herein have the same meanings as appreciated by those skilled in the field to which the present invention pertains. In general, the nomenclature used herein is well-known in the art and is ordinarily used.

Mitochondria for Transplantation into the Heart and Method of Preparing the Same

In one embodiment of the present invention, the present inventors transplanted mitochondria isolated from the gluteus maximus muscle of rats (Sprague-Dawley rats) into the heart with ischemia-reperfusion injury using a Langendorff system, and confirmed the cardioprotective effect of the transplanted mitochondria. Specifically, mitochondria sequentially isolated using a first buffer containing sucrose, EDTA, and Tris-base, and a second buffer containing EDTA, Tris-base, KCl, and BSA were transplanted into the heart with ischemia-reperfusion injury. The result showed that a mitochondrial respiratory control ratio (RCR) was increased and expression levels of Cpt1b and Fads1, as genes associated with fatty acid metabolism, were restored to normal levels, which indicates that myocardial energy metabolism disrupted by ischemia-reperfusion injury was restored.

Accordingly, in one aspect, the present invention is directed a to method of preparing mitochondria for transplantation into the heart, the method including:
(a) mixing and homogenizing an isolated tissue with a first buffer containing 150 mM to 280 mM sucrose, 0.1 mM to 5 mM ethylene diamine tetraacetic acid (EDTA), and 5 mM to 40 mM Tris-base, followed by centrifugation to obtain a pellet containing mitochondria; and
(b) resuspending the pellet containing mitochondria in a second buffer containing 0.1 mM to 5 mM EDTA, 5 mM to 40 mM Tris-base, 100 mM to 300 mM KCl, and 0.5 to 1.5 g/L of bovine serum albumin (BSA), followed by centrifugation to obtain mitochondria for transplantation into the heart.

In one embodiment of t the present invention, the mitochondria for transplantation into the heart were prepared by homogenizing the isolated tissue to prepare a homogenate of the isolated tissue, mixing the homogenate of the isolated tissue with a buffer having a predetermined composition, and performing centrifugation.

As used herein, the term “isolated tissue” refers to tissue isolated and obtained from a subject by any method known in the art. The isolated tissue may be obtained from a mammal and may, for example, be obtained from a rat, a mouse, a rabbit, a pig, or a dog, but is not limited thereto. In one embodiment of the present invention, the mammal may be a human.

The isolated tissue may include at least one selected from the group consisting of muscle tissue, liver tissue, kidney tissue, and brain tissue, is preferably muscle tissue, fat tissue, liver tissue, or skin tissue, and is more preferably skeletal muscle, gluteus muscle, deltoid muscle, pectoralis muscle, biceps muscle, triceps muscle, forearm muscle, trapezius muscle, quadriceps muscle, or gastrocnemius muscle, but is not limited thereto.

As used herein, the term “homogenization” refers to physically disrupting the isolated tissue to achieve homogenization. The homogenization may be performed by a homogenization method known in the art using a homogenization device such as a glass-Teflon homogenizer, a sonicator, a bead mill, an overhead stirrer, a Potter-Elvehjem homogenizer, or a Dounce homogenizer, but is not limited thereto. In one embodiment of the present invention, the tissue was homogenized using an overhead stirrer.

As used herein, the term “transplantation” generally refers to introducing and engrafting an organ, tissue, cell, or organelle into a subject. In the present invention, the mitochondria prepared by the method of the present invention may be transplanted into cardiac tissue or cardiomyocytes of a subject, thereby supplementing and restoring the functions of damaged cardiomyocytes.

The transplantation of the mitochondria into cardiomyocytes may be performed by a method such as intracoronary injection, direct intramyocardial injection, or intravenous administration, but is not limited thereto.

Upon transplantation of the mitochondria, the transplanted mitochondria may be autologous mitochondria or exogenous mitochondria, and the exogenous mitochondria may be allogeneic or xenogeneic.

The mitochondria prepared by the method of the present invention exhibit superior cardioprotective effects compared to mitochondria prepared by a conventional method.

As used herein, the term “first buffer” may be used interchangeably with “MIB 1 solution” and “MK01 solution”. In the present invention, the first buffer may be used to homogenize tissue and isolate mitochondria from the tissue, but is not limited thereto.

In the present invention, a concentration of the sucrose in the first buffer may be 150 mM to 280 mM, preferably 175 mM to 275 mM, 200 mM to 270 mM, more preferably 225 mM to 260 mM, and most preferably 250 mM, but is not limited thereto.

In the present invention, a concentration of the EDTA in the first buffer may be 0.1 mM to 5 mM, preferably 0.2 mM to 3 mM, 0.3 mM to 1 mM, more preferably 0.4 mM to 0.8 mM, and most preferably 0.5 mM, but is not limited thereto.

In the present invention, a concentration of the Tris-base in the first buffer may be 5 mM to 40 mM, preferably 6 mM to 20 mM, 7 mM to 15 mM, more preferably 8 mM to 12 mM, and most preferably 10 mM, but is not limited thereto.

In the present invention, the first buffer may not contain mannitol.

In the present invention, the first buffer may not contain BSA.

In the present invention, the first buffer may not contain 4-(2-hydroxyethyl)-1-piperazineethanesulfonic acid (HEPES).

In the present invention, the first buffer may not contain ethylene glycol tetraacetic acid (EGTA).

In some embodiments, the first buffer may not contain KCl.

In other embodiments, the first buffer may contain KCl and a concentration of the KCl in the first buffer may be 100 mM to 300 mM, preferably 120 mM to 250 mM, 150 mM to 200 mM, more preferably 170 mM to 190 mM, and most preferably 180 mM, but is not limited thereto.

In a preferred embodiment, the first buffer may contain 250 mM sucrose, 0.5 mM EDTA, and 10 mM Tris-base.

As used herein, the term “second buffer” may be used interchangeably with “MIB 2 solution” and “MK02 solution”. In the present invention, the second buffer may be used to resuspend isolated mitochondria and remove impurities, but is not limited thereto.

In the present invention, a concentration of the EDTA in the second buffer may be 0.1 mM to 5 mM, preferably 0.2 mM to 3 mM, 0.3 mM to 1 mM, more preferably 0.4 mM to 0.8 mM, and most preferably 0.5 mM, but is not limited thereto.

In the present invention, a concentration of the Tris-base in the second buffer may be 5 mM to 40 mM, preferably 6 mM to 20 mM, 7 mM to 15 mM, more preferably 8 mM to 12 mM, and most preferably 10 mM, but is not limited thereto.

In the present invention, a concentration of the KCl in the second buffer may be 100 mM to 300 mM, preferably 120 mM to 250 mM, 150 mM to 200 mM, more preferably 170 mM to 190 mM, and most preferably 180 mM, but is not limited thereto.

In the present invention, a concentration of the BSA in the second buffer may be 0.5 g/L to 1.5 g/L, preferably 0.6 g/L to 1.4 g/L, 0.7 g/L to 1.3 g/L, more preferably 0.8 g/L to 1.2 g/L, and most preferably 1 g/L, but is not limited thereto.

In the present invention, the second buffer may not contain sucrose.

In the present invention, the second buffer may not contain ethylene glycol tetraacetic acid (EGTA).

In the present invention, the second buffer may not contain mannitol.

In the present invention, the second buffer may not contain 4-(2-hydroxyethyl)-1-piperazineethanesulfonic acid (HEPES).

In a preferred embodiment, the second buffer may contain 0.5 mM EDTA, 10 mM Tris-base, 180 mM KCl, and 1 g/L of BSA.

In one embodiment of the present invention, when mitochondria were isolated using a first buffer containing 250 mM sucrose, 0.5 mM EDTA, and 10 mM Tris-base, and a second buffer containing 0.5 mM EDTA, 10 mM Tris-base, 180 mM KCl, and 1 g/L of BSA, and the isolated mitochondria were transplanted into a heart, an excellent cardioprotective effect against ischemia-reperfusion injury was obtained.

In the present invention, each of the first buffer and the second buffer may have a pH of 6.75 to 7.4, preferably 6.8 to 7.4, more preferably 7.0 to 7.4, and most preferably 7.4 at 4 °C, but is not limited thereto.

In one embodiment of the present invention, it was confirmed that the pH of the first buffer and the pH of the second buffer were both 7.4 at 4 °C, and in another embodiment of the present invention, it was confirmed that the pH of the first buffer and the pH of the second buffer were 6.75 and 6.8, respectively, at 25 °C.

In the present invention, step (a) may include:
(a-1) mixing and homogenizing a homogenate of the isolated tissue with the first buffer, followed by centrifugation to obtain a supernatant; and
(a-2) centrifuging the obtained supernatant to obtain a pellet containing mitochondria.

The composition of the first buffer in step (a) of the present invention may be the same as described above.

In the present invention, the centrifugation of step (a-1) may be performed at 500×g to 2,000×g, preferably 600×g to 1,800×g, more preferably 700×g to 1, 500×g, further preferably 800×g to 1,200×g, and most preferably 1,000×g, but is not limited thereto.

In the present invention, the centrifugation of step (a-2) may be performed at 5,000×g to 10,000×g, preferably 5,500×g to 9,000×g, more preferably 6,000×g to 8, 500×g, further preferably 6,500×g to 8,000×g, and most preferably 7,000×g, but is not limited thereto.

In the present invention, the centrifugation of step (a-1) may be performed one or more times and may be repeated two or more times, but is preferably repeated twice. When the centrifugation of step (a-1) is repeated, the supernatant is obtained and centrifuged.

In the present invention, the centrifugation of step (a-2) may be performed one or more times, and may be performed two or more times, but is preferably performed once. When the centrifugation of step (a-2) is repeated, the obtained pellet is suspended in the first buffer and then centrifuged.

In the present invention, the centrifugation of step (a) may be performed at a low temperature, preferably at 0 °C to 10 °C, more preferably 1 °C to 8 °C, further preferably 2 °C to 6 °C, and most preferably at 4 °C, but is not limited thereto.

In the present invention, step (b) includes suspending the pellet containing mitochondria obtained in step (a) in the second buffer, followed by centrifugation to obtain mitochondria.

The composition of the second buffer in step (b) of the present invention described above may be the same as described above.

In the present invention, the centrifugation of step (b) may be performed at 5,000×g to 10,000×g, preferably 5,500×g to 9,000×g, more preferably 6,000×g to 8,500×g, further preferably 6, 500×g to 8,000×g, and most preferably 7,000×g, but is not limited thereto.

In the present invention, the centrifugation of step (b) may be performed one or more times and may be repeated two or more times, but is preferably repeated twice. When the centrifugation of step (b) is repeated, the obtained pellet is suspended in the second buffer and then centrifuged.

In one embodiment of the present invention, the pellet containing mitochondria obtained in step (a) was centrifuged at 7,000×g and 4 °C for 10 minutes to obtain a pellet, and the pellet was suspended in the second buffer and centrifuged again under the same conditions (7,000×g, 4 °C, 10 minutes) to obtain a mitochondrial pellet.

In the present invention, the centrifugation of step (b) is preferably performed at a low temperature, preferably at 0 °C to 10 °C, more preferably 1 °C to 8 °C, further preferably 2 °C to 6 °C, and most preferably at 4 °C, but is not limited thereto.

In the present invention, the centrifugation may be performed for 1 to 30 minutes, preferably 3 to 20 minutes, more preferably 5 to 15 minutes, and most preferably 8 to 12 minutes, and the duration of the centrifugation may be appropriately adjusted depending on the number of centrifugations and the amount of the sample.

In the present invention, the method of preparing mitochondria for transplantation into the heart may further include suspending the mitochondria obtained in step (b) in a physiological buffer.

In the present invention, the physiological buffer is a buffer that maintains an ionic composition and osmotic pressure similar to an in vivo environment, and may, for example, include at least one selected from the group consisting of Tyrode's Normal (NT) solution, Ringer's solution, Hartmann's solution, normal saline, and phosphate buffered saline (PBS), but is not limited thereto. The physiological buffer used in one embodiment of the present invention was Normal Tyrode's (NT) solution containing 143 mM NaCl, 5.4 mM KCl, 5 mM HEPES, 0.5 mM MgCl₂, 0.3 mM NaH₂PO₄, 1.8 mM CaCl₂), and 5.5 mM glucose, and having pH adjusted to 7.4.

In the present invention, the physiological buffer may include NaCl, KCl, HEPES (4-(2-hydroxyethyl)-1-piperazineethanesulfonic acid), MgCl₂, NaH₂PO₄, CaCl₂, and glucose, but is not limited thereto.

In the present invention, the concentration of NaCl in the physiological buffer may be 80 mM to 200 mM, 100 mM to 180 mM, 120 mM to 160 mM, and most preferably 143 mM, but is not limited thereto.

In the present invention, the concentration of KCl in the physiological buffer may be 2 mM to 10 mM, 3 mM to 8 mM, 4 mM to 6 mM, and most preferably 5.4 mM, but is not limited thereto.

In the present invention, the concentration of HEPES in the physiological buffer may be 2 mM to 10 mM, 3 mM to 8 mM, 4 mM to 6 mM, and most preferably 5 mM, but is not limited thereto.

In the present invention, the concentration of MgCl₂ in the physiological buffer may be 0.2 mM to 1 mM, 0.3 mM to 0.8 mM, 0.4 mM to 0.6 mM, and most preferably 0.5 mM, but is not limited thereto.

In the present invention, the concentration of NaH₂PO₄ in the physiological buffer may be 0.1 mM to 0.6 mM, 0.15 mM to 0.5 mM, 0.2 mM to 0.4 mM, and most preferably 0.3 mM, but is not limited thereto.

In the present invention, the concentration of CaCl₂) in the physiological buffer may be 1 mM to 4 mM, 1.2 mM to 3 mM, 1.5 mM to 2 mM, and most preferably 1.8 mM, but is not limited thereto.

In the present invention, the concentration of glucose in the physiological buffer may be 2 mM to 10 mM, 3 mM to 8 mM, 4 mM to 6 mM, and most preferably 5.5 mM, but is not limited thereto.

In one embodiment of the present invention, the physiological buffer may be NT solution (Normal Tyrode's solution). The NaCl contained in the physiological buffer is disposed in extracellular fluid, acts to maintain osmotic pressure, and is involved in neurotransmission and muscle contraction. KCl is involved in regulation of cell membrane potential, cardiac rhythm, and transmission of muscle excitation. CaCl₂) is involved in myocardial contraction, neurotransmission, and intracellular signal transduction. MgCl₂ is involved in ATP stabilization, Ca²⁺ regulation, and regulation of enzyme activity. NaH₂PO₄ is required for phosphate buffering and cellular metabolism, and glucose serves as an energy source for cells and is particularly used in glucose metabolism of the myocardium.

The NT solution is a physiological solution used to maintain osmotic pressure, ion concentrations, and pH at constant levels so that cells or tissues can be maintained in a physiologically stable state and can be used particularly in cardiac perfusion, electrophysiology, and muscle contraction experiments. In the present invention, the NT solution may be used to achieve functional stability of tissue by maintaining physiological ion concentrations and pH during cardiac perfusion.

Kit for Preparing Mitochondria for Transplantation into the Heart

In Another Aspect, the Present Invention is Directed to a Kit for Preparing Mitochondria for Transplantation into the Heart, Including:
a first buffer containing 150 mM to 280 mM sucrose, 0.1 mM to 5 mM EDTA, and 5 mM to 40 mM Tris-base; and
a second buffer containing 0.1 mM to 5 mM EDTA, 5 mM to 40 mM Tris-base, 100 mM to 300 mM KCl, and 0.5 g/L to 1.5 g/L of BSA.

The compositions of the first buffer and the second buffer included in the kit for preparing mitochondria for transplantation into the heart according to the present invention may be the same as described above with respect to the preparation method.

In a preferred embodiment, the first buffer may contain 250 mM sucrose, 0.5 mM EDTA, and 10 mM Tris-base.

In a preferred embodiment, the second buffer may contain 0.5 mM EDTA, 10 mM Tris-base, 180 mM KCl, and 1 g/L of BSA, but is not limited thereto.

The kit of the present invention may optionally further include, the physiological buffer described above or other reagents required for performing centrifugation, in addition to the first buffer and the second buffer. In addition, the optimal amounts of reagents used in a specific reaction may be readily determined by those skilled in the art based on the disclosure herein. The kit may optionally further include a homogenization device for tissue disruption, a tube for centrifugation or the like. Typically, the kit may be provided in a separate package or compartment including the aforementioned components.

Mitochondria for Transplantation into the Heart and Medical Composition for Preventing or Treating Ischemic Heart Disease Containing the Same

In another aspect, the present invention is directed to mitochondria for transplantation into the heart prepared by the preparation method.

The mitochondria for transplantation into the heart according to the present invention have excellent protective effects against ischemia-reperfusion injury.

In present the mitochondria for the invention, transplantation into the heart reduce expression of one or more genes selected from the group consisting of Cpt1b and Fads1 upon transplantation of mitochondria into the cardiomyocytes. Specifically, the mitochondria for transplantation into the heart restore increased expression of Cpt1b and Fads1 genes caused by ischemia-reperfusion injury to normal levels.

In one embodiment of the present invention, it was confirmed that, when the mitochondria for transplantation into the heart prepared by the preparation method were transplanted into cardiomyocytes with ischemia-reperfusion injury, expression of Cpt1b and Fads1 genes increased by ischemia-reperfusion injury was reduced to normal levels and oxygen consumption capacity of the cardiomyocytes was restored.

As used herein, the term “mitochondria” refers to a major energy-producing organelle within cells that generates ATP through cellular respiration, which serves as a main energy source to maintain cell survival and function. Particularly in high-energy-demand tissues such as the heart, mitochondria supply energy using not only carbohydrates but also fatty acids as major substrates, and β-oxidation of fatty acids is one of the key metabolic pathways occurring in mitochondria. Fatty acids are converted into acetyl-CoA through β-oxidation, acetyl-CoA enters the TCA cycle to produce NADH and FADH₂, and ATP is subsequently produced through the electron transport chain. As such, mitochondria play a key role in energy production through fatty acid metabolism, and smooth progression of the corresponding pathway is essential for maintaining metabolic homeostasis in tissues such as the myocardium.

In the present invention, Cpt1b (carnitine palmitoyltransferase 1B) is an enzyme located on the outer mitochondrial membrane that mediates transport of acyl-CoA into the mitochondrial matrix by conjugating the acyl-CoA with carnitine. This is essential for initiating transport of the fatty acid into β-oxidation pathway and is particularly active in high-energy-demand tissues such as the heart and skeletal muscle. Cpt1b is critical for maintaining energy production via mitochondria, and when the function of Cpt1b is impaired, fatty acids are not properly oxidized and accumulate, leading to lipid accumulation, deterioration of cardiac function, and insulin resistance. In Cpt1b knockout mice, fatty acid oxidation is deteriorated and lipid accumulation occurs. This gene is associated with fatty acid oxidation (Warfel et al., 2016) and thus plays a key role in fatty acid oxidation.

In the present invention, Fads1 (fatty acid desaturase 1) is a 45 fatty acid desaturase that facilitates desaturation of polyunsaturated fatty acids (PUFAs) and is involved in biosynthetic pathways of arachidonic acid (AA) and eicosapentaenoic acid (EPA) using linoleic acid (LA) or alpha-linolenic acid (ALA) as a precursor. PUFA generated by Fads1 acts as a precursor of anti-inflammatory mediators and contributes to maintenance of membrane fluidity and signal transduction systems, and cardiovascular protection. Silencing of the Fads1 gene has been shown to induce apoptosis and increase reactive oxygen species (ROS) generation (Tang et al., 2019), which suggests that this gene plays a key role in survival of healthy cells and regulation of oxidative stress.

In another aspect, the present invention is directed to a medical composition for preventing or treating ischemic heart disease containing the mitochondria for transplantation into the heart as an active ingredient.

In another aspect, the present invention is directed to a method of preventing or treating ischemic heart disease including administering the mitochondria for transplantation into the heart to a subject with ischemic heart disease.

In another aspect, the present invention is directed to use of the mitochondria for transplantation into the heart for the prevention or treatment of ischemic heart disease.

In another aspect, the present invention is directed to use of the mitochondria for transplantation into the heart for the preparation of a drug for preventing or treating ischemic heart disease.

The characteristics of the mitochondria for transplantation into the heart and the preparation method thereof may be the same as those described above.

As used herein, the term “active ingredient” refers to a component that exhibits activity alone or exhibits activity in combination with an auxiliary agent (carrier) that does not exhibit activity alone.

As used herein, the terms “prevention” and “treatment” should be construed in the broadest sense. The term “prevention” refers to any act of inhibiting progression of one or more clinical symptoms of a disease in a patient who has been exposed to the disease or is susceptible thereto but has not yet experienced or manifested the symptoms of the disease. The term “treatment” refers to any act of inhibiting or reducing development of a disease or one or more clinical symptoms thereof.

In view of the objects of the present invention, “prevention” of ischemic heart disease refers to any act of suppressing occurrence of ischemic heart disease or delaying onset thereof by administration of the composition according to the present invention, and “treatment” refers to any act by which symptoms of ischemic heart disease are ameliorated or cured by administration of the composition according to the present invention.

As used herein, the term “ischemic heart disease (IHD)” refers to a group of diseases caused by narrowing or blockage of coronary arteries used to supply blood to the heart, resulting in reduced blood flow and oxygen supply to the myocardium. Ischemic heart disease leads to myocardial injury due to an imbalance between metabolic demand and supply in the myocardium, and representative diseases thereof include angina pectoris, myocardial infarction, ischemic cardiomyopathy, acute coronary syndrome and the like. In particular, ischemia-reperfusion (IR) injury, which occurs when blood flow is restored after ischemia, induces additional damage and cell death of cardiomyocytes through overproduction of reactive oxygen species (ROS), Ca²⁺ overload, and opening of the mitochondrial permeability transition pore (mPTP).

The mitochondria for transplantation into the heart according to the present invention and the medical composition containing the same have been found to restore functional impairment of cardiomyocytes damaged by ischemia-reperfusion injury and may be used for prevention or treatment of ischemic heart disease due to protective effects thereof on the myocardium.

In the present invention, the concentration of the mitochondria for transplantation into the heart in the medical composition may be 0.1 to 200 ng/ml, preferably 0.1 to 150 ng/ml, 0.1 to 100 ng/ml, or 0.1 to 50 ng/ml, but is not limited thereto. In addition, the concentration of the mitochondria for transplantation into the heart in the medical composition may be more preferably 0.2 to 20 ng/ml, 0.3 to 10 ng/ml, or 0.5 to 5 ng/mL, even more preferably 0.75 to 2 ng/ml or 1 to 1.5 ng/ml, and most preferably 1.15 ng/ml, but is not limited thereto.

The medical composition for preventing or treating ischemic heart disease according to the present invention may further contain a pharmaceutically acceptable carrier and may be formulated along with a carrier.

As used herein, the term “pharmaceutically acceptable carrier” refers to a carrier or diluent that does not irritate a subject and does not impair the biological activity and properties of the administered compound. The pharmaceutically acceptable carrier for compositions formulated as liquid solutions may be sterile and biocompatible and may be saline, sterile water, Ringer's solution, buffered saline, dextrose solution, maltodextrin solution, glycerol, ethanol, or a mixture thereof. If necessary, the pharmaceutically acceptable carrier may further contain a conventional additive such as an antioxidant, a buffer, or a bacteriostatic agent. In addition, the composition may be prepared into an injectable formation such as an aqueous solution, a suspension, or an emulsion by further adding a diluent, dispersant, surfactant, binder, or lubricant thereto. Furthermore, the composition may be appropriately formulated depending on each disease or component using methods known in the art or methods described in Remington's Pharmaceutical Sciences (Mack Publishing Company, Easton, PA).

In one embodiment of the present invention, the pharmaceutical composition may contain NT solution (Normal Tyrode's solution) as a pharmaceutically acceptable carrier. The details of the present embodiment may be the same as described above.

As used herein, the term “administration” refers to introducing the medical composition of the present invention into a patient by an appropriate method. The composition of the present invention may be administered through various oral or parenteral routes, as long as it can reach the target tissue. Specifically, the medical composition may be administered by a conventional method via a local, intra-arterial, intravenous, intramuscular, transdermal, intranasal, intraocular, or intradermal route. In view of the objects of the present invention, the medical composition is preferably administered via intracoronary infusion, direct intramyocardial injection, or intravenous administration.

In the present invention, the medical composition is preferably administered via intracoronary infusion, direct intramyocardial injection, or intravenous administration, but is not limited thereto.

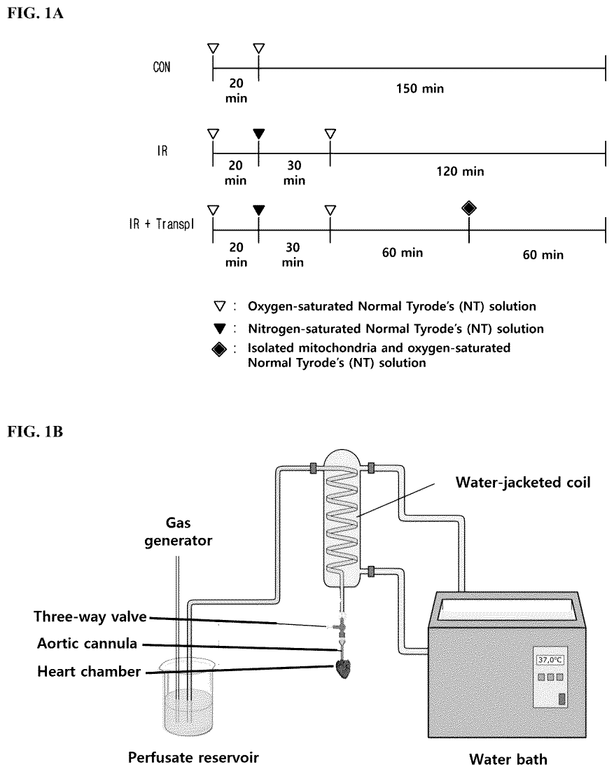

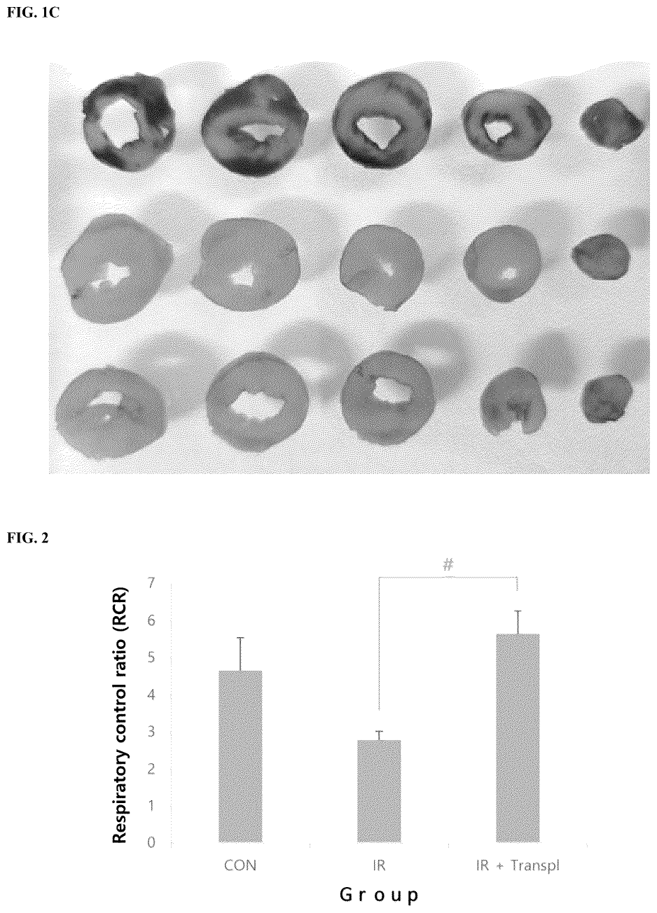

In one embodiment of the present invention, the medical composition may be administered using a Langendorff system shown in FIG. 1B. In the system, oxygen and nitrogen bubbles are generated in a gas generator and the gas is supplied through a three-way valve to a heart chamber connected to an aortic opening. A perfusate supplied to the heart is a normal tyrode's (NT) solution prepared in a perfusate reservoir and may be a normal glucose-containing NT solution or a deoxygenated glucose NT solution. The perfusate is maintained at 37 °C by water supplied from a water bath through a water-jacket coil. The water jacket includes a coil through which the NT solution flows and a hot water layer surrounding the coil, thereby enabling stable maintenance of the temperature of the NT solution. In one embodiment of the present invention, the administration may be performed by perfusion, preferably at a temperature of 30 to 40 °C, more preferably 35 to 38 °C, and most preferably 37 °C.

The method of the present invention includes administering a pharmaceutically effective amount of the medical composition of the present invention. It will be apparent to those skilled in the art that an appropriate total daily dose is determined by a physician within the scope of sound pharmaceutical judgment. A specific therapeutically effective amount for any particular patient is preferably determined in consideration of various factors well known in the field of pharmaceuticals, including the type and extent of the desired response, the specific composition, whether other agents are used in combination, the patient's age, body weight, general health condition, gender, and diet, the time and route of administration, the rate of excretion of the composition, the duration of treatment, and drugs used in combination with or concurrently with the specific composition. Accordingly, the effective amount of the pharmaceutical composition suitable for the objects of the present invention is preferably determined in consideration of the foregoing factors.

### Example

Hereinafter, the present invention will be described in more detail with reference to the following examples. However, it will be obvious to those skilled in the art that the following examples are provided only for illustration of the present invention and should not be construed as limiting the scope of the present invention.

### EXAMPLES

### Example 1. Experimental Animals

Sprague-Dawley rats (male, 7 weeks old, body weight 200±10 g, Koatech, Republic of Korea) were used. All animal experiments were conducted after approval from the Institutional Animal Care and Use Committee (IACUC) of Chung-Ang University (Approval No.: 202301020113). The rats of the present invention were bred under controlled environmental conditions of temperature 18 to 25 °C, humidity of 40 to 60%, ventilation at 14 to 18 air changes per hour, and illumination of 150 to 300 lux, and were subjected to a cycle of 12 hours of light followed by 12 hours of darkness. During the experimental period, water and food were freely fed.

FIG. 1A is a schematic diagram illustrating a process of establishing a cardiac ischemia model for mitochondrial transplantation. As shown in FIG. 1A, the rats were randomly assigned into three groups: a normal group (control, CON), an ischemia-reperfusion group (IR), and an ischemia-reperfusion-mitochondrial transplantation group (IR+Transpl).

### Example 2. Heart Excision

Animals were deeply anesthetized via intravenous administration of alfaxalone (5 mg/kg; Alfaxan, JUROX Pty Limited), xylazine hydrochloride (5 mg/kg; Rompun inj., BAYER KOREA Ltd), and heparin (300 IU/kg; Greencross Heparin Sodium Inj., GC Biopharma Corporation). After confirmation of deep anesthesia, the animals were euthanized by thoracotomy and heart excision. In a Petri dish containing Normal Tyrode's solution (NT solution) (143 mM NaCl, 5.4 mM KCl, 5 mM HEPES, 0.5 mM MgCl₂, 0.3 mM NaH₂PO₄, 1.8 mM CaCl₂), 5.5 mM glucose, pH 7.4), tissues and blood surrounding the heart were removed and the aorta and a cannula were then ligated with a suture. The heart was then used for experiments using a Langendorff system.

### Example 3. Langendorff System

The Langendorff system (Jeongwoo Science, Republic of Korea) was washed by flowing sterile water and NT solution for 5 minutes each, and the system was preheated to 37 °C using a circulating water bath (Changshin Science, Republic of Korea), followed by performing the experiment (FIG. 1B). In all groups, the excised hearts were mounted on the Langendorff system and stabilized by perfusion with oxygen-saturated NT solution for 20 minutes prior to the experiment. The control group was perfused with oxygen-saturated NT solution for 150 minutes. The IR group was subjected to perfusion with nitrogen-saturated NT solution for 30 minutes to induce ischemia, followed by reperfusion with oxygen-saturated NT solution for 60 minutes, to induce reperfusion injury. The IR+Transpl group was subjected to ischemia-reperfusion injury in the same manner as the IR group, followed by transplantation by perfusion of isolated mitochondria for 60 minutes. The hearts were perfused in a retrograde manner under a constant-flow mode and the flow rate was controlled at 7±1 mL/min.

### Example 4. Isolation and Transplantation of Mitochondria

After euthanasia, approximately 1 g of the gluteus maximus was collected from the rats and then transferred to a 50 mL tube, and 5 to 10 mL of a first buffer (250 mM sucrose, 0.5 mM EDTA-Na₂, 10 mM Tris-base, pH 7.4 at 4 °C) was added thereto. The tissue was finely minced using medical scissors and homogenized using a tissue homogenizer (Daihan Scientific, Republic of Korea). After homogenization, the homogenate was subjected to low-temperature centrifugation (Vision Scientific, Republic of Korea) at 1,000×g and at 4 °C for 10 minutes, and the supernatant was transferred to a fresh tube and centrifuged again under the same conditions. The resulting supernatant was then subjected to high-speed refrigerated centrifugation (Vision Scientific, Republic of Korea) at 7,000×g for 10 minutes at 4 °C, and the supernatant was removed to obtain a pellet.

The obtained pellet was resuspended in 5 to 10 mL of a second buffer (180 mM KCl, 0.5 mM EDTA-Na₂, 10 mM Tris-base, 1 g/L of BSA, pH 7.4 at 4 °C) and centrifuged again at 7,000×g at 4 °C for 10 minutes. The supernatant was removed and the pellet was resuspended in 5 to 10 mL of MIB-2 solution and centrifuged once more under the same conditions to obtain a mitochondrial pellet. The isolated mitochondria were subjected to protein assay and then the protein was diluted with NT solution to approximately 1.15 ng/ml, followed by perfusion for 60 minutes and transplantation.

### Example 5. Preparation of Permeabilized Fibers

Permeabilized fibers are used in this experiment because they are suitable for evaluation of oxygen consumption capacity while maintaining in vivo structural integrity without isolating: mitochondria. The endocardium of the ventricular portion of the heart after completion of perfusion in the Langendorff system was dissected in the tissue fiber direction using surgical scissors and forceps. The endocardium is suitable as an experimental material because it exhibits the highest oxygen consumption among left ventricular myocardium, is most vulnerable to ischemic injury, and easily secures experimental consistency. The dissected myocardial tissue was placed into a tube containing 2 mL of a solution prepared by mixing an isolation solution A (10 mM Ca-EGTA solution, 0.1 μM Ca²⁺, 20 mM imidazole, 20 mM taurine, 49 mM K-MES, 3 mM K₂HPO₄, 9.5 mM MgCl₂, 5.7 mM ATP, 15 mM phosphocreatine, 1 μM leupeptin, pH 7.1) supplemented with 10 mM Ca-EGTA solution (2.77 mM CaK₂EGTA stock solution, 7.23 mM K₂EGTA stock solution) with 50 μg/mL of saponin, and gently agitated (minimum speed, 20 minutes, 4 °C) to prepare permeabilized fibers (the CaK₂EGTA stock solution contained 100 mM CaCO₃, 100 mM EGTA, and 200 mM KOH, and the K₂EGTA stock solution contained 100 mM EGTA and 200 mM KOH). Then, in order to remove saponin and ATP, the tissue was added to 2 mL of respiration medium B (0.5 mM EGTA, 3 mM MgCl₂·6H₂O, 20 mM taurine, 10 mM KH₂PO₄, 20 mM HEPES, 1 g/L of BSA, 60 mM K-lactobionate, 110 mM mannitol, 0.3 mM DTT, pH 7.1) supplemented with 1 mg/mL of fatty acid-free BSA, and gently agitated (minimum speed, 5 minutes, 4 °C) 3 to 4 times. The prepared samples were then used for measurement of mitochondrial oxygen consumption capacity (60 mM K-lactobionate was prepared using a 500 mM K-lactobionate stock solution).

### Example 6. Identification of Non-Infarcted Area

After completion of the experimental protocol, 0.6 mL of 0.25% Evans blue dye was uniformly injected through the aortic cannula. Then, the heart was frozen at −20 °C for 2 hours and then sectioned transversely at a thickness of 5 mm. The regions stained blue indicate non-ischemic areas whereas pale or unstained regions indicate infarcted myocardium or viable myocardium within the area at risk.

FIG. 1C shows heart sections stained with the 0.25% Evans blue. The upper panel shows heart sections from the control group (CON) stained with the 0.25% Evans blue. The middle panel shows heart sections from the ischemia-reperfusion (IR) group, and the lower panel shows heart sections from the ischemia-reperfusion with mitochondrial transplantation group (IR+Transpl). The non-ischemic area in the IR group was much smaller than that in the control group and such reduction was not restored in the IR+Transpl group.

These results indicate that mitochondrial transplantation may have limited effects on structural recovery of IR-injured hearts and suggest that mitochondrial transplantation primarily focuses on functional recovery of IR-injured hearts by improving metabolic stability and cellular function, thereby providing cardioprotective effects.

### Example 7. Confirmation of Recovery of Mitochondrial Function

### Example 7-1: Measurement of Oxygen Consumption Capacity of Mitochondria and Calculation of Respiratory Control Ratio (RCR)

To measure oxygen consumption capacity, tissue and solution were injected into a chamber (Instech, USA) connected to a NeoFox (Ocean Optics, USA), and the oxygen consumption rate (OCR) was monitored using NeoFox Viewer (version 2.30, Ocean Optics, USA).

The chamber was preheated to 37 °C using a circulating water bath (Changshin Science, Republic of Korea), and 100 μL of respiration medium B was added to the chamber. The solution was stabilized for 10 to 15 minutes using a magnetic stir bar until the graph in the viewer became stable. Then, permeabilized fibers, G/M (10 mM glutamate+5 mM malate), and 2 mM adenosine diphosphate (ADP) were sequentially added thereto, and changes in oxygen levels within the chamber were monitored to measure oxygen consumption capacity. State 3 refers to a phase in which mitochondria actively respire in the presence of substrate and ADP and exhibit a sharp increase in oxygen consumption, whereas state 4 refers to a phase in which oxygen consumption slows after ADP is phosphorylated to form ATP. The slopes of the state 3 and state 4 regions were calculated using Microsoft Excel, and the respiratory control ratio (RCR) was determined as the ratio of the slope of state 3 to that of state 4.

FIG. 2 shows the respiratory control ratio (RCR) obtained after measurement of oxygen consumption capacity to evaluate mitochondrial function. Oxygen consumption capacity was measured twice for each group and RCR was calculated from the oxygen consumption capacity. The IR group exhibited a decreased (1.68-fold lower) oxygen consumption capacity compared to the control group. On the other hand, the IR+Transpl group exhibited an increased (2.04-fold higher) oxygen consumption capacity compared to the IR group. These results indicate that mitochondrial transplantation increased oxygen consumption rate and enhanced oxidative phosphorylation capacity in response to ADP, thereby increasing the respiratory control ratio. This suggests that the transplanted mitochondria were functionally activated to improve cellular energy production efficiency.

### Example 7-2: Measurement of Mitochondrial Copy Number

Mitochondrial copy number was measured using myocardial DNA. DNA was extracted using a QIAamp DNA Mini Kit (Qiagen, USA) and quantified using a UV spectrophotometer (Nanodrop 1000, Thermo Fisher Scientific, USA), and 8 ng of DNA was used for analysis. Real-time PCR was performed using a LightCycler 2.0 (Roche Diagnostics, USA). The PCR conditions were as follows: initial denaturation at 95 °C for 10 minutes, followed by 35 cycles of denaturation at 95 °C for 10 seconds, annealing at 60 °C for 10 seconds, and elongation at 72 °C for 10 seconds. Melting curve analysis was then performed at 65 to 95 °C and at a rate of 0.1 °C/second. The primers used herein are shown in Table 1. Since the extracted DNA includes both genomic DNA (gDNA) and mitochondrial DNA (mtDNA), expression levels were quantified by comparing mitochondrial copy number with nuclear gene copy number. The equation used for quantification of the expression levels and the calculation of respiratory control ratio (RCR) per mitochondrion are as follows:

ΔCt=mtDNA Ct−gDNA Ct

Relative DNA copy number=2×2−^{ΔCt}

Respiratory control ratio (RCR) per mitochondrion=RCR/mitochondrial copy number

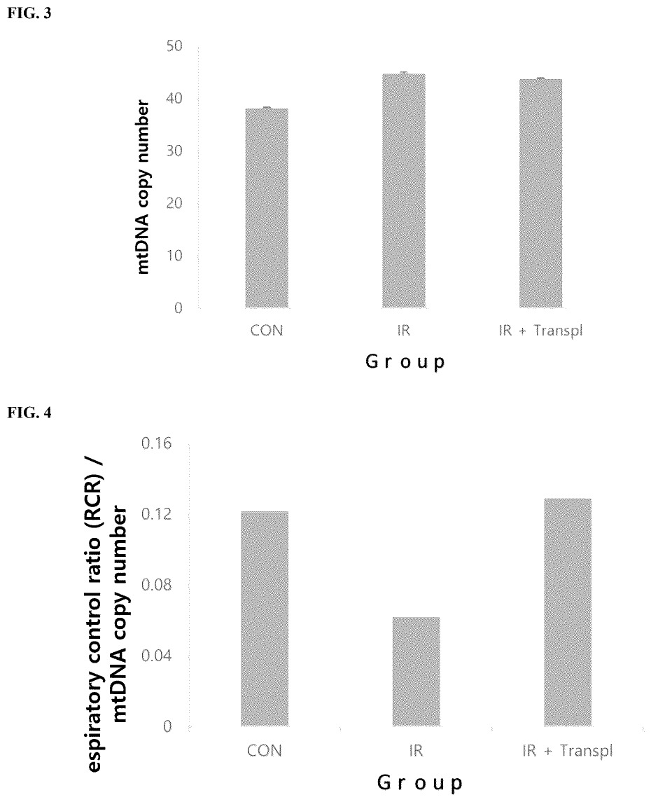

FIG. 3 shows mitochondrial copy number measured to determine RCR per mitochondrion. The mtDNA copy number (mtDNA-CN) was found to be similar across all groups.

These results indicate that mitochondrial transplantation improves energy production efficiency through functional enhancement, rather than increasing mitochondrial DNA content in cells.

TABLE 1

| | |
|---|---|
| SEQ | |
| ID | Annealing |

| | | | | |
|---|---|---|---|---|
| Primer | Sequence 5′→3′ | NO. | Temp (°C) | Cycles |

MT copy number

| | | | | | |
|---|---|---|---|---|---|
| MT | Forward | GCCACACATCAGACATCCACA | 1 | 58 | 35 |
| | Reverse | GGGCGTAATGAAAGAGGCAA | 2 | | |
| Gapdh | Forward | TGCTTCACCACCTTCTTGAT | 3 | 60 | 35 |
| | Reverse | TGGAAAGCTGTGGCGTGAT | 4 | | |

Real-Time PCR

| | | | | | |
|---|---|---|---|---|---|
| Gapdh | Forward | TGCTTCACCACCTTCTTGAT | 3 | 60 | 35 |
| | Reverse | TGGAAAGCTGTGGCGTGAT | 4 | | |
| Cpt1b | Forward | CAGCCCATGGCACCAAGATC | 5 | 61 | 40 |
| | Reverse | AAGGGCCGCAGGACATACC | 6 | | |
| Elov15 | Forward | AGATAATGCAGTGGTGTGAAGC | 7 | 61 | 40 |
| | Reverse | AGGCCCGGCAGGAGATAAGA | 8 | | |
| Fads1 | Forward | ATGCCCCTTCTTTCGCTTTCC | 9 | 61 | 40 |
| | Reverse | TGTGAGGGGCATAAAGCAGC | 10 | | |
| Gja1 | Forward | GCTTTGTGACTGGAAGCCGA | 11 | 61 | 40 |
| | Reverse | AAGAGTGGAGGAGGAAGAGG | 12 | | |

MT: mitochondria genome, Gapdh: glyceraldehyde-3-phosphate dehydrogenase gene, Cpt1b: carnitine palmitoyltransferase 1B), Elov15: ELOVL fatty acid elongase 5, Fads1: fatty acid desaturase 1, Gja1: gap junction alpha 1

### Example 7-3: Respiratory Control Ratio Per Mitochondrion

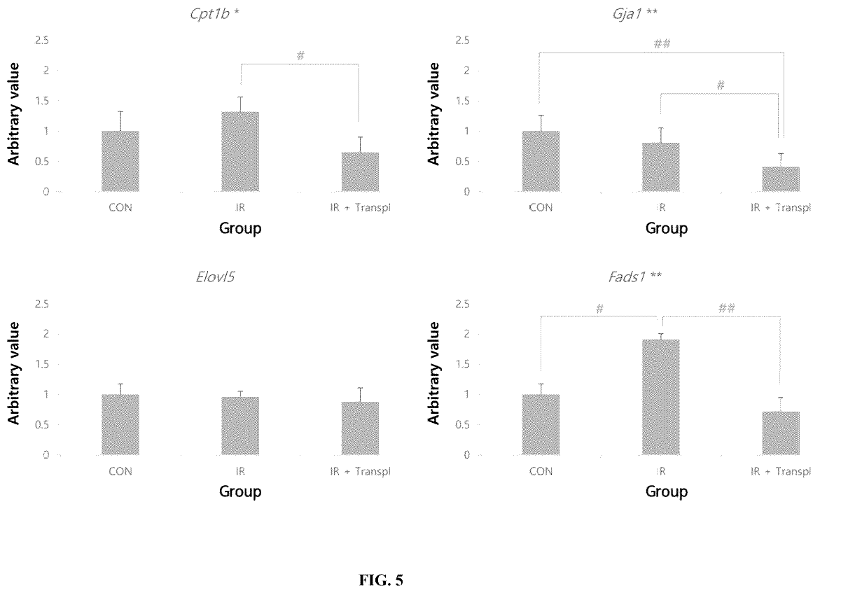

FIG. 4 shows the calculated respiratory control ratio per mitochondrion. IR injury decreased the respiratory control ratio per mitochondrion (ratio of RCR to mtDNA copy number), but the respiratory control ratio per mitochondrion was restored after mitochondrial transplantation.

These results indicate that mitochondrial transplantation can restore mitochondrial function in IR-injured hearts.

### Example 8. Analysis of Expression Levels of Oxidative Stress-Related Genes by Mitochondria

Under normal conditions, the heart primarily uses fatty acids as a major energy substrate, and selectively uses in the order of carbohydrates, ketones, and amino acids depending on physiological conditions. Such metabolic flexibility is a physiological regulatory mechanism to efficiently maintain cardiac functions and is associated with mitochondrial energy metabolism and regulation of oxidative stress.

To evaluate changes in expression of genes related to mitochondrial oxidative stress response and metabolism, real-time PCR was performed using a LightCycler 2.0 (Roche Diagnostics, USA). The PCR conditions were as follows: initial denaturation at 95 °C for 10 minutes, followed by 40 cycles of denaturation at 95 °C for 10 seconds, annealing at a temperature appropriate for each primer for 10 seconds, and elongation at 72 °C for 10 seconds. Melting curve analysis was then performed at 65 to 95 °C and at a rate of 0.1 °C/second. The primers used and annealing temperatures are shown in Table 1. Expression levels of candidate genes were normalized to expression of a reference gene, Gapdh, and relative quantification was performed using the 2^{-ΔΔct} method:

ΔCt=Candidate Ct−Reference gene Ct

ΔΔCt=Experimental group ΔCt−Control group ΔCt

Relative expression level=2^{-ΔΔCt}

The list of genes related to fatty acid metabolism obtained from previous studies in rat skeletal muscle and myocardial tissues was integrated with the KEGG dataset [rno01212: Fatty acid metabolism-Rattus norvegicus (rat)]. A total of 62 genes were identified, from which four genes were randomly selected. Relative expression levels of Cpt1b, Gja1, Fads1, and Elov15 were determined by real-time PCR.

FIG. 5 shows relative expression levels of Cpt1b, Gja1, Fads1, and Elov15. Relative expression levels of Cpt1b (p<0.05), Gja1 (p<0.01), and Fads1 (p<0.01) differed among groups, whereas Elov15 did not show significant differences among the groups. The expression level of Fads1 was higher in the IR group than in the control group (p<0.05) and was lower in the IR+Transpl group than in the IR group (p<0.01). The expression level of Gja1 was lower in the IR+Transpl group than in the control group (p<0.01) and the IR group (p<0.05).

These results indicate that normal fatty acid oxidation was impaired by IR injury, and expression of Cpt1b was increased as a compensatory response. In the IR+Transpl group, reduced expression of Cpt1b causes recovery of fatty acid metabolism and cardioprotective effects by mitochondrial transplantation. In addition, increased expression of Fads1 gene in the IR group indicates a protective response to excessive reactive oxygen species generation and cellular damage in the myocardium, whereas decreased expression of Fads1 in the IR+Transpl group indicates restoration toward normal levels by mitochondrial transplantation, reflecting inhibition of apoptosis. Furthermore, lower expression of Gja1 in the IR+Transpl group compared with the IR group indicates that mitochondrial transplantation provides protective effects, thereby reducing the need for Gja1 expression.

Overall, these results demonstrate that mitochondrial transplantation improves metabolic alterations such as impaired fatty acid metabolism and accumulation of reactive oxygen species caused by ischemia-reperfusion injury, and promotes recovery and protection of cardiomyocyte function through regulation of expression of Cpt1b, Fads1, and Gja1 genes.

Although specific configurations of the present invention have been described in detail, those skilled in the art will appreciate that this detailed description is provided as preferred embodiments for illustrative purposes and should not be construed as limiting the scope of the present invention. Therefore, the substantial scope of the present invention is defined by the accompanying filed claims and equivalents thereto.

1. A method of preparing mitochondria for transplantation into the heart, comprising:
(a) mixing and homogenizing an isolated tissue with a first buffer comprising 150 mM to 280 mM sucrose, 0.1 mM to 5 mM ethylene diamine tetraacetic acid (EDTA), and 5 mM to 40 mM Tris-base, followed by centrifugation to obtain a pellet containing mitochondria; and
(b) resuspending the pellet containing mitochondria in a second buffer comprising 0.1 mM to 5 mM EDTA, 5 mM to 40 mM Tris-base, 100 mM to 300 mM KCl, and 0.5 to 1.5 g/L of bovine serum albumin (BSA), followed by centrifugation to obtain mitochondria for transplantation into the heart.

2. The method according to claim 1, wherein the first buffer does not comprise KCl.

3. The method according to claim 1, wherein the first buffer does not comprise BSA.

4. The method according to claim 1, wherein the second buffer does not comprise sucrose.

5. The method according to claim 1, wherein the second buffer does not comprise ethylene glycol tetraacetic acid (EGTA).

6. The method according to claim 1, wherein each of the first buffer and the second buffer has a pH of 6.75 to 7.4.

7. The method according to claim 1, wherein the first buffer consists of 250 mM sucrose, 0.5 mM EDTA, and 10 mM Tris-base.

8. The method according to claim 1, wherein the second buffer consists of 0.5 mM EDTA, 10 mM Tris-base, 180 mM KCl, and 1 g/L of BSA.

9. The method according to claim 1, wherein the isolated tissue is muscle tissue.

10. The method according to claim 1, wherein step (a) comprises:
(a-1) mixing and homogenizing a homogenate of the isolated tissue with the first buffer, followed by centrifugation at 500×g to 2,000×g to obtain a supernatant; and
(a-2) centrifuging the obtained supernatant at 5,000×g to 10,000×g to obtain a pellet containing mitochondria.

11. The method according to claim 10, wherein the centrifugation in step (a-1) is performed two or more times.

12. The method according to claim 1, wherein the centrifugation in step (b) is performed at 5,000×g to 10,000×g.

13. The method according to claim 12, wherein the centrifugation in step (b) is performed two or more times.

14. A kit for isolating mitochondria for transplantation into the heart, comprising:
a first buffer comprising 150 mM to 280 mM sucrose, 0.1 mM to 5 mM EDTA, and 5 mM to 40 mM Tris-base; and
a second buffer comprising 0.1 mM to 5 mM EDTA, 5 mM to 40 mM Tris-base, 100 mM to 300 mM KCl, and 0.5 g/L to 1.5 g/L of BSA.

15. The kit according to claim 14, wherein the first buffer consists of 250 mM sucrose, 0.5 mM EDTA, and 10 mM Tris-base.

16. The kit according to claim 14, wherein the second buffer consists of 0.5 mM EDTA, 10 mM Tris-base, 180 mM KCl, and 1 g/L of BSA.

17. A method of preventing or treating ischemic heart disease comprising administering mitochondria for transplantation into the heart, prepared by the method according to claim 1, to a subject with ischemic heart disease.

18. The method according to claim 17, wherein a concentration of the mitochondria for transplantation into the heart is 0.1 to 200 ng/mL.

19. The method according to claim 17, wherein the administration is performed via intracoronary infusion, direct intramyocardial injection, or intravenous administration.


SEQUENCE LISTING (12 sequences)

SEQ ID NO: 1 - DNA, 21 bp, synthetic construct
  source 1..21: mol_type = other DNA
gccacacatcagacatccaca

SEQ ID NO: 2 - DNA, 20 bp, synthetic construct
  source 1..20: mol_type = other DNA
gggcgtaatgaaagaggcaa

SEQ ID NO: 3 - DNA, 20 bp, synthetic construct
  source 1..20: mol_type = other DNA
tgcttcaccaccttcttgat

SEQ ID NO: 4 - DNA, 19 bp, synthetic construct
  source 1..19: mol_type = other DNA
tggaaagctgtggcgtgat

SEQ ID NO: 5 - DNA, 20 bp, synthetic construct
  source 1..20: mol_type = other DNA
cagcccatggcaccaagatc

SEQ ID NO: 6 - DNA, 19 bp, synthetic construct
  source 1..19: mol_type = other DNA
aagggccgcaggacatacc

SEQ ID NO: 7 - DNA, 22 bp, synthetic construct
  source 1..22: mol_type = other DNA
agataatgcagtggtgtgaagc

SEQ ID NO: 8 - DNA, 20 bp, synthetic construct
  source 1..20: mol_type = other DNA
aggcccggcaggagataaga

SEQ ID NO: 9 - DNA, 21 bp, synthetic construct
  source 1..21: mol_type = other DNA
atgccccttctttcgctttcc

SEQ ID NO: 10 - DNA, 20 bp, synthetic construct
  source 1..20: mol_type = other DNA
tgtgaggggcataaagcagc

SEQ ID NO: 11 - DNA, 20 bp, synthetic construct
  source 1..20: mol_type = other DNA
gctttgtgactggaagccga

SEQ ID NO: 12 - DNA, 20 bp, synthetic construct
  source 1..20: mol_type = other DNA
aagagtggaggaggaagagg